(19) United States
(12) Patent Application Publication
(10) Pub. No.: US 2023/0071703 A1
(43) Pub. Date: Mar. 9, 2023

(54) INTELLIGENT DEVICE, INTELLIGENT SPEAKER, AND METHOD AND SYSTEM FOR CONTROLLING THE SAME

(71) Applicant: SUZHOU TOUCHAIR TECHNOLOGY CO., LTD., Suzhou (CN)

(72) Inventors: Guangsong Liu, Suzhou (CN); Zirui Wang, Suzhou (CN); Qing Yang, Suzhou (CN)

(21) Appl. No.: 18/054,911

(22) Filed: Nov. 13, 2022

Related U.S. Application Data
(63) Continuation-in-part of application No. PCT/CN2021/075138, filed on Feb. 4, 2021.

(30) Foreign Application Priority Data
May 13, 2020 (CN) 202010402875.X

(51) Int. Cl. G01S 5/26; H04R 1/32; G01S 5/24

(52) U.S. Cl. CPC G01S 5/26; H04R 1/326; G01S 5/24; H04R 2201/40; H04R 2430/21

(57) ABSTRACT

The present application provides an intelligent device, an intelligent speaker, and a method and system for controlling the same. The intelligent device includes a first sound detection module configured to detect a first sound signal directly reaching the first sound detection module; an angle determination module configured to determine a time difference between the receiving time of the first sound signal and the receiving time of the second sound signal, and determine a relative angle between the intelligent device and the intelligent speaker based on a distance between the first sound detection module and the second sound detection module and the time difference; and a transmitting module configured to transmit a notification message containing the relative angle to the intelligent speaker, so that the intelligent speaker directionally transmits a sound to the intelligent device based on the relative angle. Directional sounding based on relative angle calculation is realized.

### CROSS REFERENCE TO RELATED APPLICATIONS

The present application is a Continuation-In-Part Application of PCT Application No. PCT/CN2021/075138 filed on Feb. 4, 2021, which claims the benefit of Chinese Patent Application No. 202010402875.X filed on May 13, 2020. All the above are hereby incorporated by reference in their entirety.

### TECHNICAL FIELD

The embodiments of the present application relate to the technical field of sound processing, and in particular to an intelligent device, an intelligent speaker, and a method and system for controlling the same.

### BACKGROUND

With the continuous development of indoor positioning technology and communication technology, the functions of mobile terminals are increasingly rich, greatly improving the convenience and entertainment of people's daily work and life. At present, most of the intelligent speakers launched in the market play according to the preset loudness, or the mobile terminal can be used to wirelessly control the audio play and volume adjustment.

At present, in the method of controlling the audio volume and direction of the intelligent speaker based on the user position, the existing technology mainly determines the user's distance by the volume of the voice picked up by the microphone array, or obtains the user position through the range sensor, and then feeds back to the intelligent speaker to adjust the volume.

### SUMMARY

The embodiments of the present application provide an intelligent device, an intelligent speaker, and a method and system for controlling the same.

In a first aspect, the present application provides an intelligent device, including:

a first sound detection module configured to detect a first sound signal directly reaching the first sound detection module;

a second sound detection module configured to detect a second sound signal directly reaching the second sound detection module, the first sound signal and the second sound signal being simultaneously transmitted by the same intelligent speaker;

an angle determination module configured to determine a time difference between the receiving time of the first sound signal and the receiving time of the second sound signal, and determine a relative angle between the intelligent device and the intelligent speaker based on a distance between the first sound detection module and the second sound detection module and the time difference; and

a transmitting module configured to transmit a notification message containing the relative angle to the intelligent speaker, so that the intelligent speaker directionally transmits a sound to the intelligent device based on the relative angle.

In a second aspect, the present application provides a method for controlling an intelligent speaker, wherein the method is applicable to an intelligent device including a first sound detection module and a second sound detection module, and the method includes:

detecting a first sound signal directly reaching the first sound detection module, and detecting a second sound signal directly reaching the second sound detection module, the first sound signal and the second sound signal being simultaneously transmitted by the same intelligent speaker;

determining a time difference between the receiving time of the first sound signal and the receiving time of the second sound signal;

determining a relative angle between the intelligent device and the intelligent speaker based on a distance between the first sound detection module and the second sound detection module and the time difference; and

transmitting a notification message containing the relative angle to the intelligent speaker, so that the intelligent speaker directionally transmits a sound to the intelligent device based on the relative angle.

In a third aspect, the present application provides a system for controlling an intelligent speaker, including:

the intelligent speaker configured to transmit a sound signal; and

an intelligent device including a first sound detection module configured to detect a first sound signal directly reaching the first sound detection module in the sound signal; a second sound detection module configured to detect a second sound signal directly reaching the second sound detection module in the sound signal, the first sound signal and the second sound signal being simultaneously transmitted by the same intelligent speaker; an angle determination module configured to determine a time difference between the receiving time of the first sound signal and the receiving time of the second sound signal, and determine a relative angle between the intelligent device and the intelligent speaker based on a distance between the first sound detection module and the second sound detection module and the time difference; and a transmitting module configured to transmit a notification message containing the relative angle to the intelligent speaker, wherein the intelligent speaker is further configured to directionally transmit a sound to the intelligent device based on the relative angle.

In a fourth aspect, the present application provides an intelligent speaker, including:

a first sound detection module configured to detect a first sound signal directly reaching the first sound detection module;

a second sound detection module configured to detect a second sound signal directly reaching the second sound detection module, the first sound signal and the second sound signal being simultaneously transmitted by the same sounding device;

an angle determination module configured to determine a time difference between the receiving time of the first sound signal and the receiving time of the second sound signal, and determine a relative angle between the intelligent speaker and the sounding device based on a distance between the first sound detection module and the second sound detection module and the time difference; and

a sounding module configured to directionally transmit a sound to the sounding device based on the relative angle.

In a fifth aspect, the present application provides a method for controlling an intelligent speaker, wherein the intelligent speaker includes a first sound detection module and a second sound detection module, and the method includes:

detecting a first sound signal directly reaching the first sound detection module, and detecting a second sound signal directly reaching the second sound detection module, the first sound signal and the second sound signal being simultaneously transmitted by the same sounding device;

determining a time difference between the receiving time of the first sound signal and the receiving time of the second sound signal;

determining a relative angle between the intelligent speaker and the sounding device based on a distance between the first sound detection module and the second sound detection module and the time difference; and

directionally transmitting a sound to the sounding device based on the relative angle.

In a sixth aspect, the present application provides a system for controlling an intelligent speaker, including:

a sounding device; and

an intelligent speaker including a first sound detection module configured to detect a first sound signal directly reaching a first sound detection module; a second sound detection module configured to detect a second sound signal directly reaching a second sound detection module, the first sound signal and the second sound signal being simultaneously transmitted by the sounding device; an angle determination module configured to determine a time difference between the receiving time of the first sound signal and the receiving time of the second sound signal, and determine a relative angle between the intelligent speaker and the sounding device based on a distance between the first sound detection module and the second sound detection module and the time difference; and a sounding module configured to directionally transmit a sound to the sounding device based on the relative angle.

In a seventh aspect, the present application provides a computer-readable storage medium, storing computer-readable instructions for executing any one of the methods for controlling the intelligent speaker.

According to any one of the aspects, the present application realizes directional sounding based on relative angle calculation, and improves the user experience.

### DESCRIPTION OF THE DRAWINGS

FIG. 1 illustrates an exemplary flowchart of a method for determining a relative angle between intelligent devices according to the present application.

FIG. 2 illustrates a schematic diagram of determining a relative angle between intelligent devices according to the present application.

FIG. 3 illustrates a schematic diagram of calculating a relative angle between intelligent devices according to the present application.

FIG. 4 illustrates a first exemplary schematic diagram of determining a pair of directly reaching signals according to the present application.

FIG. 5 illustrates a second exemplary schematic diagram of determining a pair of directly reaching signals according to the present application.

FIG. 6 illustrates a first exemplary arrangement schematic diagram of a first sound detection module and a second sound detection module according to the present application.

FIG. 7 illustrates a second exemplary arrangement schematic diagram of a first sound detection module and a second sound detection module according to the present application.

FIG. 8 illustrates a relative positioning schematic diagram of a first intelligent device and a second intelligent device according to the present application.

FIG. 9 illustrates a schematic diagram of presenting a relative angle in an interface of an intelligent device according to the present application.

FIG. 10 illustrates an exemplary processing flowchart of relative positioning between intelligent devices according to the present application.

FIG. 11 illustrates a structural diagram of an intelligent device according to the present application.

FIG. 12 illustrates a flowchart of a method for controlling an intelligent speaker according to the present application.

FIG. 13 illustrates a structural diagram of a system for controlling an intelligent speaker according to the present application.

FIG. 14 illustrates a structural diagram of an intelligent speaker according to the present application.

FIG. 15 illustrates a flowchart of a method for controlling an intelligent speaker according to the present application.

FIG. 16 illustrates a structural diagram of a system for controlling an intelligent speaker according to the present application.

### DESCRIPTION OF THE EMBODIMENTS

In order to make the purposes, technical schemes and advantages of the present application more clear, the present application will be further described in detail below with reference to the drawings.

In order to realize the relative positioning between intelligent devices without adding additional hardware and using software, so that the relative positioning is universal, devices from different manufacturers can achieve interoperability and compatibility, and innovative applications of intelligent devices can be explored based on this, the embodiment of the present application provides a scheme for recognizing a relative direction between intelligent devices based on sound (ultrasonic preferred), which can use software to realize the relative direction recognition between two intelligent devices without adding additional hardware. The positioning result is accurate and reliable.

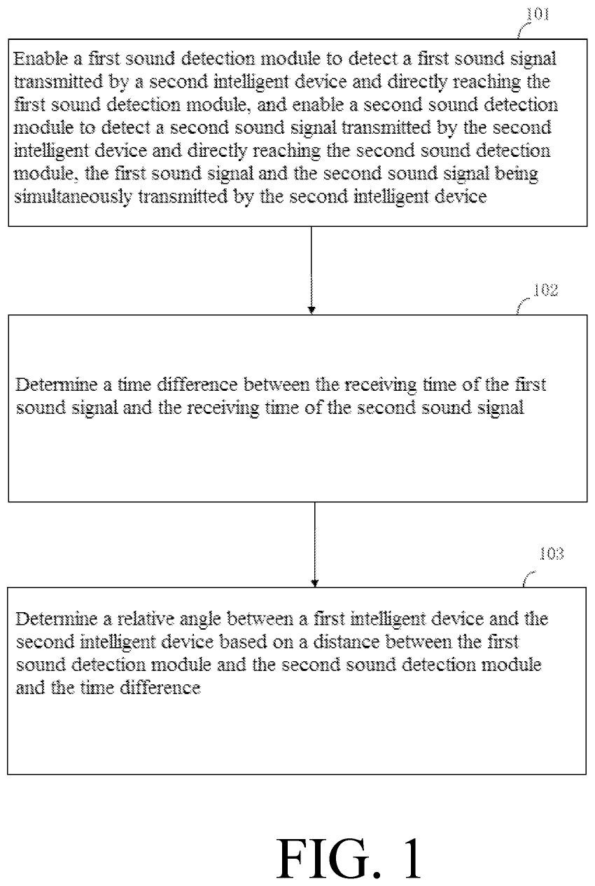

Firstly, an intelligent device refers to any kind of device, apparatus or machine with a computing ability. FIG. 1 illustrates an exemplary flowchart of a method for determining a relative angle between intelligent devices according to the present application. The method is applicable to a first intelligent device. The first intelligent device includes a first sound detection module and a second sound detection module. The first sound detection module and the second sound detection module are fixedly mounted in the first intelligent device. For example, the first sound detection module may be implemented as a microphone or a microphone array arranged in the first intelligent device. Similarly, the second sound detection module may be implemented as a microphone or a microphone array arranged in the first intelligent device, different from the first sound detection module.

Referring to FIG. 1, the method includes the following steps:

In step 101, the first sound detection module is enabled to detect a first sound signal transmitted by the second intelligent device and directly reaching the first sound detection module, and the second sound detection module is enabled to detect a second sound signal transmitted by the second intelligent device and directly reaching the second sound detection module. The first sound signal and the second sound signal are simultaneously transmitted by the second intelligent device.

Here, the second intelligent device may transmit one sound signal or a plurality of sound signals simultaneously.

For example, when the second intelligent device transmits one sound signal, the first sound detection module and the second sound detection module in the second intelligent device respectively detect the sound signal. A detected signal detected by the first sound detection module and directly reaching the first sound detection module is determined as the first sound signal. A detected signal of the sound signal detected by the second sound detection module and directly reaching the first sound detection module is determined as the second sound signal. For another example, when the second intelligent device transmits a plurality of sound signals simultaneously, such as an ultrasonic signal and an audible sound signal, the first sound detection module in the second intelligent device is adapted to detect the ultrasonic signal, and the second sound detection module is adapted to detect the audible sound signal. A detected signal of the ultrasonic signal detected by the first sound detection module and directly reaching the first sound detection module is determined as the first sound signal. A detected signal of the audible sound signal detected by the second sound detection module and directly reaching the second sound detection module is determined as the second sound signal.

In other words, the first sound signal and the second sound signal may be respectively detected signals of the same sound signal transmitted by the first sound detection module and the second sound detection module to the second intelligent device. Alternatively, the first sound signal and the second sound signal may be respectively detected signals of different sound signals simultaneously transmitted by the first sound detection module and the second sound detection module to the second intelligent device.

In step 102, a time difference between the receiving time of the first sound signal and the receiving time of the second sound signal is determined.

Here, the first intelligent device (for example, the CPU in the first intelligent device) may record the receiving time of the first sound signal and the receiving time of the second sound signal, and calculate a time difference between them.

In step 103, a relative angle between the first intelligent device and the second intelligent device is determined based on a distance between the first sound detection module and the second sound detection module and the time difference.

For example, step 103 may be executed by the CPU of the first intelligent device.

In an embodiment, determining a relative angle between the first intelligent device and the second intelligent device in step 103 includes determining θ based on

$$θ = arcsin ( \frac{d}{D} ) ,$$

where arcsin is an arcsine function, d=t*c, t is the time difference, c is the propagation speed of sound, and D is the distance between the first sound detection module and the second sound detection module; and determining the relative angle φ between the first intelligent device and the second intelligent device based on θ, where

$$φ = \frac{π}{2} - θ .$$

The value of the time difference determined in step 102 may be positive or negative. When the value of the time difference is positive, the receiving time of the second sound signal is earlier than the receiving time of the first sound signal, so the relative angle between the first intelligent device and the second intelligent device is usually an acute angle; when the value of the time difference is negative, the receiving time of the first sound signal is earlier than the receiving time of the second sound signal, so the relative angle between the first intelligent device and the second intelligent device is usually an obtuse angle.

In the embodiment of the present application, the first sound signal is a signal directly reaching the first sound detection module from the second intelligent device, and the second sound signal is a signal directly reaching the second sound detection module from the second intelligent device. In fact, both the first sound detection module and the second sound detection module can receive non-directly reaching signals from the second intelligent device (for example, after reflected for one time or a plurality of times by obstacles). Therefore, it is significant to determine the directly reaching signal from a plurality of received signals.

As found by the applicant, in general, the received signal stream of each sound detection module includes a directly reaching channel and a reflected channel. The directly reaching channel may be determined simply and conveniently according to the following principle: among all signals detected by the sound detection module, the signal strength of the directly reaching channel is generally the highest.

Therefore, in an embodiment, the method further includes determining a sound signal with strength greater than a predetermined threshold within a predetermined time window in a sound signal stream received by the first sound detection module from the second intelligent device as the first sound signal; and determining a sound signal with strength greater than the predetermined threshold within the predetermined time window in a sound signal stream received by the second sound detection module from the second intelligent device as the second sound signal.

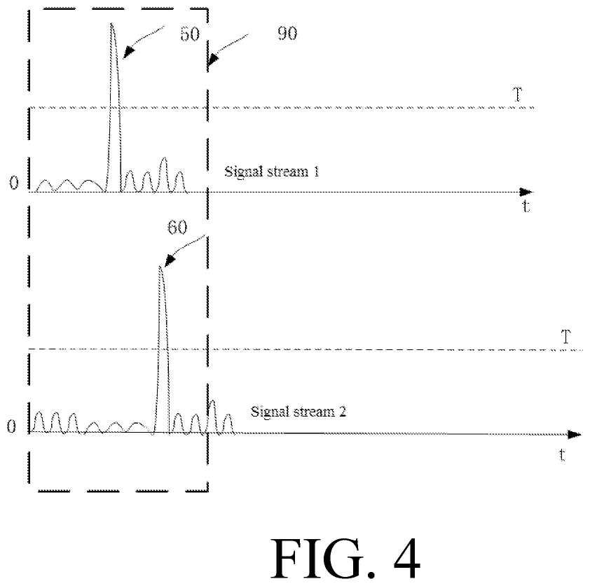

FIG. 4 illustrates a first exemplary schematic diagram of determining a pair of directly reaching signals according to the present application. In FIG. 4, a sound signal stream detected by the first sound detection module is stream1. Stream1 contains a plurality of pulse signals varying with time (t). A threshold of predetermined signal strength is T. Accordingly, within time window 90, the signal strength of pulse signal 50 in stream l is greater than the threshold T. A sound signal stream detected by the second sound detection module is stream2. Stream2 contains a plurality of pulse signals varying with time (t). The threshold of predetermined signal strength is also T. Accordingly, within time window 90, the signal strength of pulse signal 60 in stream2 is greater than the threshold T. Therefore, pulse signal 50 is determined as the first sound signal and pulse signal 60 is determined as the second sound signal.

In addition, as also found by the applicant, the following two principles may be comprehensively considered to accurately determine the directly reaching channel: principle (1), among all signals detected by the sound detection module, the signal strength of the directly reaching channel is generally the highest; principle (2) joint determination method: a distance difference d converted from a reaching time difference between two directly reaching channel signals (the first sound signal and the second sound signal) shall not be greater than the distance between the first sound detection module and the second sound detection module.

Therefore, in an embodiment, the method further includes determining sound signals with strength greater than a predetermined threshold in a sound signal stream of the second intelligent device detected by the first sound detection module to form a first candidate signal set; determining sound signals with strength greater than the predetermined threshold in a sound signal stream of the second intelligent device detected by the second sound detection module to form a second candidate signal set; determining a respective time difference between the receiving time of each sound signal in the first candidate signal set and the receiving time of each sound signal in the second candidate signal set; and determining a pair of sound signals with the time difference less than M as the first sound signal and the second sound signal, where M=(D/c), D is the distance between the first sound detection module and the second sound detection module, and c is the propagation speed of sound.

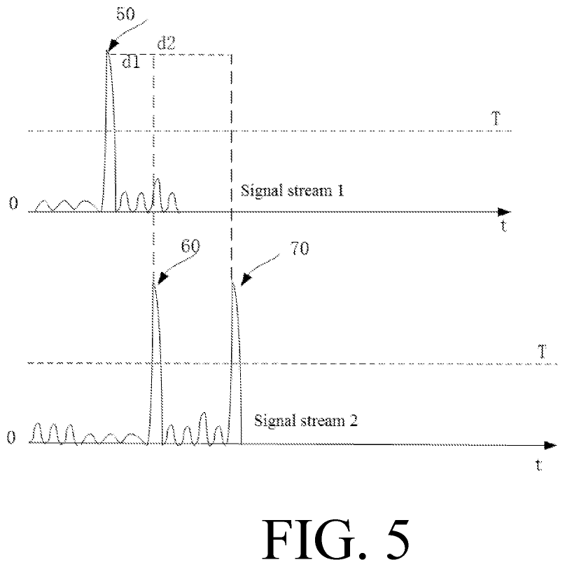

FIG. 5 illustrates a second exemplary schematic diagram of determining a pair of directly reaching signals according to the present application. In FIG. 5, a sound signal stream detected by the first sound detection module is stream1. Stream1 contains a plurality of pulse signals varying with time (t). A threshold of predetermined signal strength is T. Accordingly, in stream1, the signal strength of pulse signal 50 is greater than the threshold T, so the first candidate signal set includes pulse signal 50. A sound signal stream detected by the second sound detection module is stream2. Stream2 contains a plurality of pulse signals varying with time (t). The threshold value of predetermined signal strength is also T. Accordingly, in stream2, the signal strengths of pulse signal 60 and pulse signal 70 are both greater than the threshold T, so the second candidate signal set includes pulse signal 60 and pulse signal 70.

Further, a time difference d1 between the receiving time of pulse signal 50 in the first candidate signal set and the receiving time of pulse signal 60 in the second candidate signal set, and a time difference d2 between the receiving time of the pulse signal 50 in the first candidate signal set and the receiving time of pulse signal 70 in the second candidate signal set are determined. It is assumed that d1 is less than M and d2 is greater than M, where M=(D/c), D is the distance between the first sound detection module and the second sound detection module, and c is the propagation speed of sound. Therefore, pulse signal 50 in the pair of sound signals related to d1 is determined as the first sound signal, and pulse signal 60 in the pair of sound signals is determined as the second sound signal.

Exemplarily, the first sound signal and the second sound signal are ultrasonic waves with code division multiple access formats and contain a Media Access Control (MAC) address of the second intelligent device.

Therefore, the first intelligent device can accurately identify the source of the sound signal based on the MAC address of the second intelligent device contained in the sound signal. In a case that there are a plurality of sound sources that transmit sound signals in the environment, the first intelligent device can accurately use two directly reaching signals from the same sound source to determine a relative angle to the sound source based on the MAC address extracted from the sound signal, without being interfered by other sound sources.

The embodiment of the present application further provides a method for determining a relative angle between intelligent devices. The method is applicable to a first intelligent device. The first intelligent device includes a first sound detection module and a second sound detection module. The method includes determining first time that an ultrasonic signal transmitted by the second intelligent device directly reaches the first sound detection module; determining second time that the ultrasonic signal directly reaches the second sound detection module; determining a time difference between the first time and the second time; and determining a relative angle between the first intelligent device and the second intelligent device based on a distance between the first sound detection module and the second sound detection module and the time difference.

In an embodiment, determining a relative angle between the first intelligent device and the second intelligent device includes determining θ based on

$$θ = arcsin ( \frac{d}{D} ) ,$$

where arcsin is an arcsine function, d=t*c, t is the time difference, c is the propagation speed of sound, and D is the distance between the first sound detection module and the second sound detection module; and determining the relative angle φ between the first intelligent device and the second intelligent device based on θ, where

$$φ = \frac{π}{2} - θ .$$

In an embodiment, the method further includes at least one of the following processes:

(1) An ultrasonic signal with strength greater than a predetermined threshold in a predetermined time window in an ultrasonic signal stream received by the first sound detection module from the second intelligent device is determined as an ultrasonic signal directly reaching the first sound detection module, an ultrasonic signal with strength greater than the predetermined threshold in the predetermined time window in the ultrasonic signal stream received by the second sound detection module from the second intelligent device is determined as an ultrasonic signal directly reaching the second sound detection module, and the time of receiving the ultrasonic signal directly reaching the second sound detection module is determined as the second time.

(2) Ultrasonic signals with strength greater than the predetermined threshold in the ultrasonic signal stream of the second intelligent device detected by the first sound detection module are determined to form a first candidate signal set; ultrasonic signals with strength greater than the predetermined threshold in the ultrasonic signal stream of the second intelligent device detected by the second sound detection module are determined to form a second candidate signal set; a respective time difference between the receiving time of each ultrasonic signal in the first candidate signal set and the receiving time of each ultrasonic signal in the second candidate signal set is determined; and the receiving time of a pair of ultrasonic signals with the time difference less than M is determined as the first time and the second time, where M=(D/c), D is the distance between the first sound detection module and the second sound detection module, and c is the propagation speed of sound.

The principle and calculation process of the relative positioning of the present application will be exemplarily described below.

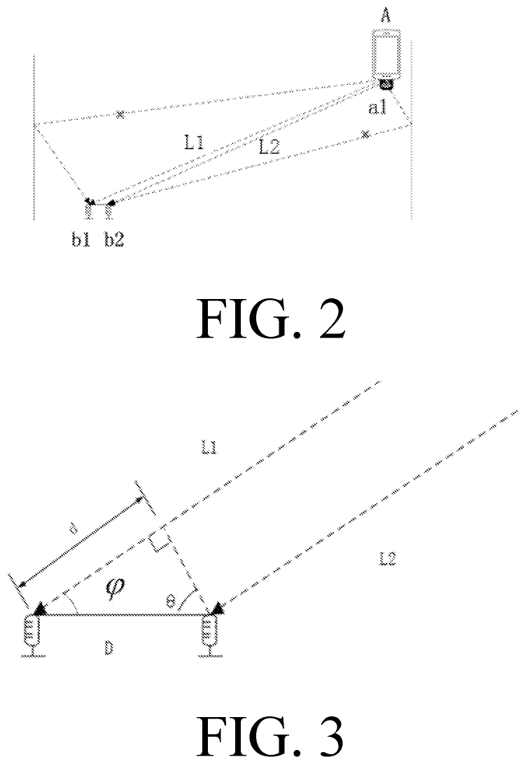

FIG. 2 illustrates a schematic diagram of determining a relative angle between intelligent devices according to the present application. FIG. 3 illustrates a schematic diagram of calculating a relative angle between intelligent devices according to the present application. Referring to FIG. 2, a microphone al arranged at a bottom of an intelligent device A transmits an ultrasonic signal. The ultrasonic signal contains an MAC address of the intelligent device A. An intelligent device B (not shown in FIG. 2) has two microphones arranged at an interval, namely a microphone b1 and a microphone b2. The microphone b1 receives a directly reaching signal L1 of the ultrasonic signal, and the microphone b2 receives a directly reaching signal L2 of the ultrasonic signal. Non-directly reaching signals reaching the microphone b1 and the microphone b2 after the ultrasonic signal is reflected by obstacles do not participate in the subsequent relative angle calculation. Since the intelligent devices are small, especially when two intelligent devices are far apart, directly reaching signals L₁ and L₂ can be regarded as parallel lines.

Referring to FIG. 3, L₁ and L₂ respectively represent the directly reaching signals (not signals reflected by the obstacles) received by the microphone b1 and the microphone b2 of the intelligent device B; D is a distance between the microphone bl and the microphone b2. For example, if the microphone b1 and the microphone b2 are respectively arranged at the upper and lower ends of the intelligent device B, then D is the length of the intelligent device B. A perpendicular line is made from the microphone b2 to the directly reaching signal L₁, a distance between a perpendicular foot and the microphone b1 is d, and d is a distance difference between L₁ and L₂. Using the related algorithm of signals, a delay time difference t of the directly reaching signal L₁ relative to the directly reaching signal L₂ can be determined, and d can be calculated based on the delay time difference t, where c is the propagation speed of sound in the medium (such as air); θ an assistant angle, where

$$θ = arcsin ( \frac{d}{D} ) .$$

Therefore, the relative angle φ between the intelligent device A and the intelligent device B can be calculated, where

$$φ = \frac{π}{2} - θ .$$

Exemplarily, the intelligent device A and the intelligent device B may be implemented as at least one of the following: smart phone, tablet PC, smart watch, smart bracelet, intelligent speaker, smart TV, smart headset, intelligent robot, etc.

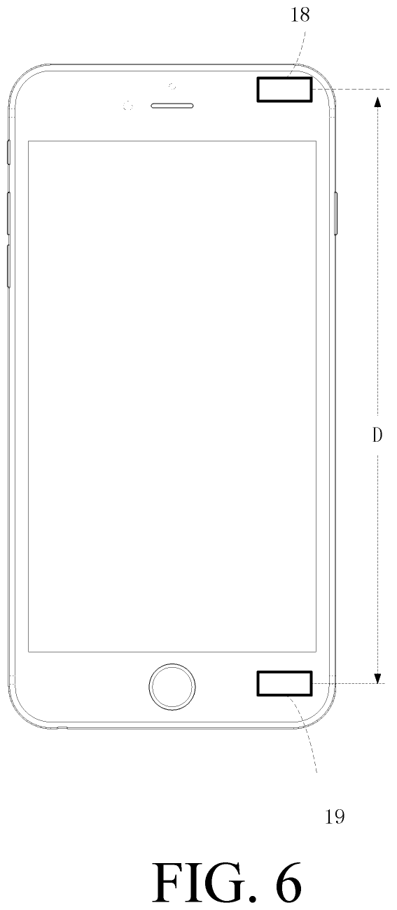

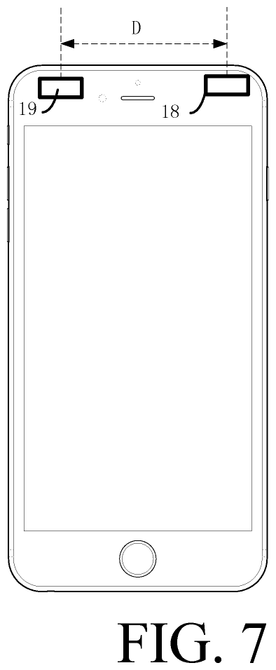

The first sound detection module and the second sound detection module may be arranged at a plurality of positions of the intelligent device. FIG. 6 illustrates a first exemplary arrangement schematic diagram of the first sound detection module and the second sound detection module according to the present application. In FIG. 6, the first sound detection module 18 and the second sound detection module 19 are respectively arranged at two ends of the intelligent device in a length direction, so the length D of the intelligent device can be directly determined as the distance between the first sound detection module 18 and the second sound detection module 19. FIG. 7 illustrates a second exemplary arrangement schematic diagram of the first sound detection module and the second sound detection module according to the present application. In FIG. 7, the first sound detection module 18 and the second sound detection module 19 are respectively arranged at two ends of the intelligent device in a width direction, so the width D of the intelligent device can be directly determined as the distance between the first sound detection module 18 and the second sound detection module 19.

The arrangement of the first sound detection module and the second sound detection module in the intelligent device is exemplarily described above. Those skilled in the art can understand that the description is only exemplary and is not intended to limit the scope of protection of the embodiment of the present application.

In fact, at present, the existing intelligent device usually has two groups of microphones, which can be used as the first sound detection module and the second sound detection module in the implementation of the present application, thus not changing the hardware of the intelligent device.

A typical example of calculating a relative angle between intelligent devices by using ultrasonic waves based on the embodiment of the present application will be described below.

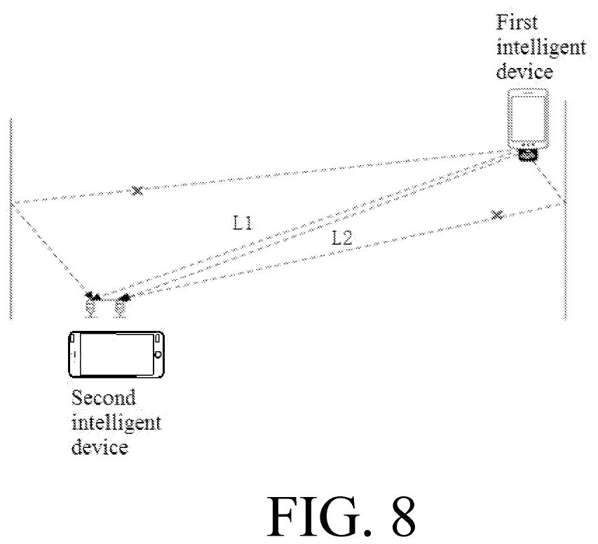

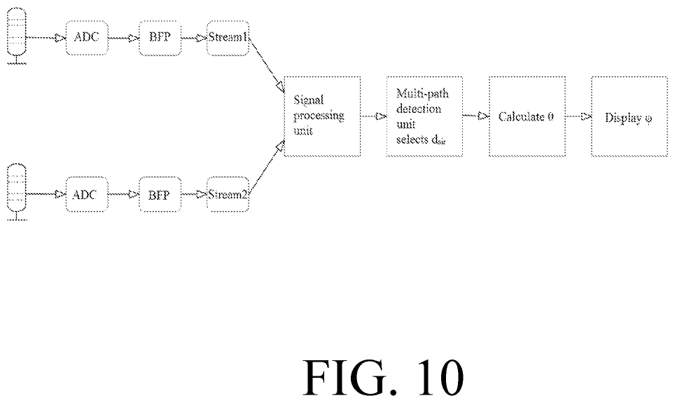

FIG. 8 illustrates a relative positioning schematic diagram of the first intelligent device and the second intelligent device according to the present application. FIG. 10 illustrates an exemplary processing flowchart of relative positioning between intelligent devices according to the present application. Respective processing paths of two groups of microphones for detecting sound signals are illustrated in FIG. 7, in which an Analog-to-Digital Converter (ADC) is a device that converts analog signals of continuous variables into discrete digital signals; a Band-Pass Filter (BPF) is a device that allows waves of a specific frequency band to pass through while shielding other frequency bands. Steps of identifying a relative direction between two intelligent devices based on ultrasound include the following steps:

In step 1, a first intelligent device transmits a positioning signal in an ultrasonic format. The positioning signal contains an MAC address of an intelligent device 1.

In step 2, two groups of microphones of a second intelligent device respectively detect the positioning signal, resolve the MAC address from the positioning signal detected thereby, and confirm that the positioning signal detected thereby originates from the same sound source based on the MAC address.

In step 3, the second intelligent device calculates a distance difference d between the two directly reaching signals based on the time difference between the two directly reaching signals of the positioning signal respectively detected by the two groups of microphones in the second intelligent device.

In step 4, the second intelligent device calculates

$$θ = arcsin ( \frac{d}{D} ) ,$$

a signal incidence angle is

$$φ = \frac{π}{2} - θ ,$$

and φ is a relative angle between the first intelligent device and the second intelligent device, where D is a distance between the two groups of microphones in the second intelligent device.

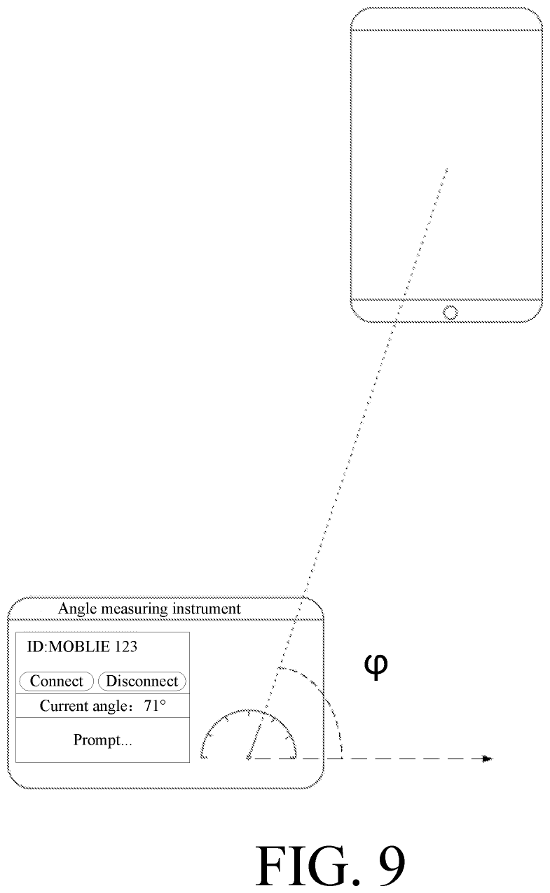

In step 5, the second intelligent device displays the relative angle φ on its own display interface, thereby prompting a user of the relative direction of the first intelligent device. For example, FIG. 9 illustrates a schematic diagram of presenting a relative angle in an interface of an intelligent device according to the present application.

For example, it is assumed that in the environment illustrated in FIG. 8, the first device is specifically implemented as an intelligent speaker, and the second intelligent device is specifically implemented as a smart phone.

In step 1, an intelligent speaker transmits an ultrasonic signal. The ultrasonic signal contains an MAC address of the intelligent speaker and is a signal based on CDMA technology architecture.

In step 2, two microphone arrays of a smart phone receive the ultrasonic signal and resolve the MAC address of the intelligent speaker. At the same time, the smart phone resolves a distance difference between two directly signals of the two microphone arrays. It is assumed that there are directly reaching signals with peak signal strength greater than a threshold T in signal streams stream1 and stream2 respectively received by the two microphone arrays, so principle 1 is satisfied. Then, assuming that a reaching time difference between these two directly reaching signals is

$$Δ t = \frac{2}{48000} ( s ) ,$$

d corresponding to this Δt is calculated, where

$$d = \frac{2}{48000} * 340 \approx 0.0 \; 14 ( m ) .$$

The distance D between the two groups of microphones is known (i.e., the length of the phone) and is assumed to be 0.145 m. Accordingly, d<D, principle 2 is satisfied. Therefore, the two directly reaching signals can be selected to calculate the relative angle, where d=0.014 (m).

In step 3, the smart phone calculates

$$θ = arcsin ( \frac{d}{D} ) = arcsin ( \frac{0.014}{0.145} ) \approx 5 . {6}^{∘} ,$$

so a signal incidence angle is

$$φ = \frac{π}{2} - θ = 84 . {4}^{∘} .$$

The smart phone displays angle 84.4° on its own display screen, that is, the intelligent speaker is in a direction of 84.4° relative to the smart phone.

The relative distance between two intelligent devices can be further obtained by using the method of identifying the relative direction between two intelligent devices. The following scenario is assumed: there are at least two intelligent devices, at least one intelligent device a is used to transmit an ultrasonic positioning signal, and the ultrasonic positioning signal contains an MAC address of the intelligent device a; at least one intelligent device b is used to receive the ultrasonic positioning signal, calculates a signal incidence angle, and calculate a relative distance to the intelligent device a after further movement.

Based on the above description, the embodiment of the present application further provides an application scenario of controlling an intelligent speaker by using an intelligent device (such as a smart phone or smart headset) that can sound according to the above relative angle calculation method.

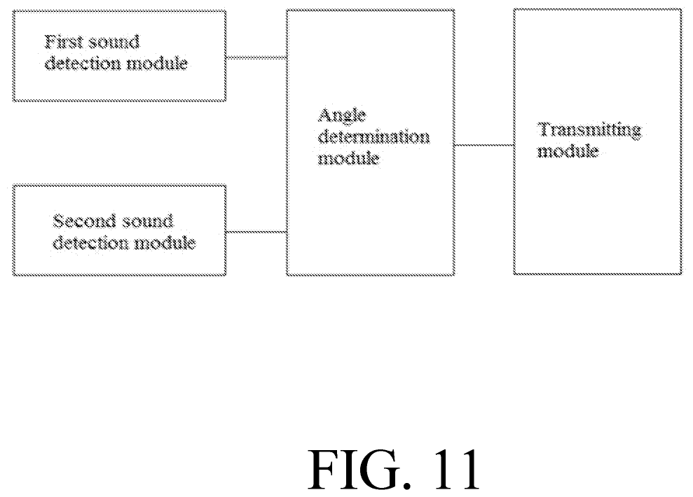

FIG. 11 illustrates a structural diagram of an intelligent device according to the present application. A first sound detection module and a second sound detection module are arranged in the intelligent device. There is a fixed distance between the first sound detection module and the second sound detection module. The size of the intelligent device is usually small, so the distance between the first sound detection module and the second sound detection module arranged in the intelligent device is far less than the distance between the intelligent device and the intelligent speaker.

Referring to FIG. 11, an intelligent device includes a first sound detection module configured to detect a first sound signal directly reaching the first sound detection module; a second sound detection module configured to detect a second sound signal directly reaching the second sound detection module, the first sound signal and the second sound signal being simultaneously transmitted by the same intelligent speaker; an angle determination module configured to determine a time difference between the receiving time of the first sound signal and the receiving time of the second sound signal, and determine a relative angle between the intelligent device and the intelligent speaker based on a distance between the first sound detection module and the second sound detection module and the time difference; and a transmitting module configured to transmit a notification message containing the relative angle to the intelligent speaker, so that the intelligent speaker directionally transmits a sound to the intelligent device based on the relative angle. The first sound detection module and the second sound detection module may be respectively implemented as a microphone or microphone array.

The intelligent device is suitable for the user to hold or wear, which, for example, may be implemented as a smart phone, a smart headset, an intelligent remote control, a tablet PC, a personal digital assistant, a smart bracelet, a pair of smart glasses, or the like.

The intelligent speaker uses the built-in microphone (or microphone array) to simultaneously transmit the first sound signal directly reaching the first sound detection module and the second sound signal directly reaching the second sound detection module. For example, the intelligent speaker can reuse an original microphone in the intelligent speaker to simultaneously transmit the first sound signal and the second sound signal. Alternatively, a microphone is added on the intelligent speaker, and the new microphone and the original microphone are used to simultaneously transmit the first sound signal and the second sound signal.

For the method for calculating the relative angle between the intelligent device and the intelligent speaker, a reference may be made to the method for determining the relative angle illustrated in FIG. 1. The intelligent device corresponds to the first intelligent device in the method illustrated in FIG. 1, and the intelligent speaker corresponds to the second intelligent device in the method illustrated in FIG. 1. The process of determining the relative angle will not be repeated here. The intelligent device can use the built-in controller to perform the relative angle determination process, or use the SCM, single board computer or DSP and other control modules to perform the relative angle determination process.

In an embodiment, the angle determination module is configured to determine θ based on

$$θ = arcsin ( \frac{d}{D} ) ,$$

where arcsin is an arcsine function, d=t*c, t is the time difference, c is the propagation speed of sound, and D is the distance between the first sound detection module and the second sound detection module; and determine the relative angle φ between the intelligent device and the intelligent speaker based on θ, where

$$φ = \frac{π}{2} - θ .$$

Moreover, the transmitting module can transmit the notification message containing the relative angle to a server or home gateway through wireless communication, so that the server or home gateway can transmit the notification message to the intelligent speaker. Optionally, the transmitting module can directly use Bluetooth communication, infrared communication, ultrasonic communication, near-field communication, purple bee communication and other communication methods to directly transmit the notification message containing the relative angle to the intelligent speaker.

After receiving the notification message, the intelligent speaker directly transmits a sound to the intelligent device based on the relative angle. For example, the intelligent speaker firstly determines a transmitting angle based on the relative angle, and then directionally transmits a sound to the intelligent device according to the transmitting angle. It can be seen that the intelligent speaker can directionally transmit a sound to the intelligent device, and the user of the intelligent device can hear the sound directionally. Therefore, the sound of the intelligent speaker in the present application is no longer diffused 360 degrees in the traditional way, but transmitted along a certain path in a certain direction.

In an embodiment, a loudspeaker array in the intelligent speaker directionally transmits a sound to the intelligent device based on the transmitting angle, or an ultrasonic directional sounder in the intelligent speaker directionally transmits a sound to the intelligent device based on the transmitting angle.

Specifically, the intelligent speaker can realize directional sound transmission based on a variety of directional sound technologies. For example:

1. Loudspeaker array technology: a large number of high-frequency speakers are used to form an array to form a beam. A beam direction, that is, a main lobe direction, has the highest energy. The beam direction is aimed at the intelligent device located based on this relative angle. Specifically, the intelligent speaker includes an array processor configured to generate an audio signal containing a beam deflection angle aimed at the intelligent device based on a transmitting angle; a digital-to-analog converter configured to convert the audio signal to an analog format; a power amplifier configured to perform power amplification on the audio signal output by the digital-to-analog converter; and a loudspeaker array configured to transmit the audio signal output by the power amplifier.

2. Acoustic frequency directional propagation technology based on ultrasound: an audible sound signal is modulated onto an ultrasonic carrier signal and transmitted to the air by an ultrasonic transducer. During the propagation of ultrasonic waves with different frequencies in the air, due to the nonlinear acoustic effect of the air, these signals will interact and be self-demodulated, thus generating a new acoustic wave with a frequency equal to the sum of the original ultrasonic frequencies (sum frequency) and the difference between the frequencies (difference frequency). If the ultrasonic waves are selected properly, the difference-frequency acoustic wave can fall in an audible area. In this way, with the aid of the high directivity of the ultrasound itself, the process of directional propagation of sound is realized. Specifically, the intelligent speaker includes an ultrasonic directional sounder.

The typical embodiment of directional sounding of the intelligent speaker is exemplarily described above. Those skilled in the art can understand that the description is only exemplary and is not intended to limit the scope of protection of the embodiment of the present application.

Specifically, the intelligent device can determine the distance between the intelligent device and the intelligent speaker based a variety of ways, such as acoustic positioning (ultrasonic positioning preferred).

Example 1: the intelligent device keeps time synchronized with the intelligent speaker. The first sound signal further contains the transmitting time T1 of the first sound signal. The intelligent device determining the distance between the intelligent device and the intelligent speaker includes that a controller in the intelligent device calculates the distance L between the intelligent device and the intelligent speaker, where L=(T2−T1)*c; c is the propagation speed of sound in the air; T2 is the receiving time of the first sound signal. Similarly, the distance between the intelligent device and the intelligent speaker can be determined by using the transmitting time contained in the second sound signal and the receiving time of the second sound signal.

Example 2: based on the rotation angle of the intelligent device and the relative angle between the intelligent device at the rotation stop position and the intelligent speaker, the distance between the intelligent device at the rotation stop position and the intelligent speaker is determined. Specifically, when the intelligent device is rotated from a first position T₁ to a second position T₂ with a fixed point A as the center, the rotation angle of the intelligent device is determined; when the intelligent device is rotated to the second position T₂, the relative angle between the intelligent device and the intelligent speaker determined based on the receiving time difference between the directly reaching sound signals transmitted by the intelligent speaker arranged at a position B to the first sound detection module and the second sound detection module on the intelligent device has changed to zero, or the relative angle continues to change to an angle α after changing to zero, where a is not more than 180 degrees; the distance between the intelligent device and the intelligent speaker is determined based on the relative angle and rotation angle.

For example, at the second position T₂, the relative angle is zero; determining the distance between the intelligent device and the intelligent speaker based on the relative angle and rotation angle includes determining the distance R₂ between the intelligent device and the intelligent speaker when the intelligent device is at the first position T₁ based on

$${R}_{1} = {R}_{{2}^{*}} \frac{sin {ψ}_{1}}{sin ( {φ}_{1} + {ψ}_{1} )} ,$$

where R₂ is the distance between the fixed point A and the intelligent device; φ₁ is the relative angle between the intelligent device and the intelligent speaker when the intelligent device is at the first position T₁; ψ₁ is the rotation angle and is the angle □T₁AB.

For another example, at the second position T₂, the relative angle is α; determining the distance between the intelligent device and the intelligent speaker based on the relative angle and rotation angle includes determining the distance R₁ between the intelligent device and the intelligent speaker when the intelligent device is at the second position T₂ based on

$${R}_{1} = {R}_{{2}^{*}} \frac{sin {ψ}_{1}}{sin ( {φ}_{1} + {ψ}_{1} )} ,$$

where R₂ is the distance between the fixed point A and the intelligent device; φ₁ is the relative angle between the intelligent device and the intelligent speaker when the intelligent device is at the second position T₂; ψ₁ is the rotation angle and is the angle <T₂AB.

Example 3: when the intelligent device moves non-rotationally from the first position to the second position, the distance between the intelligent device at the second position and the intelligent speaker is determined respectively based on the relative angle between the intelligent device at the first position and the intelligent speaker and the relative angle between the intelligent device at the second position and the intelligent speaker. The direction of the intelligent device at the second position is the same as that of the intelligent device at the first position. Specifically, when the intelligent device is at the first position, a relative angle 1 between the intelligent device and the intelligent speaker is determined based on the receiving time difference between the directly reaching sound signals transmitted by the first sound detection module and the second sound detection module arranged on the intelligent device to the intelligent speaker; when the intelligent device moves to the second position, a relative angle 2 between the intelligent device and the intelligent speaker is determined based on the receiving time difference between the directly reaching sound signals transmitted by the first sound detection module and the second sound detection module to the intelligent speaker. The direction of the intelligent device at the second position is the same as that of the intelligent device at the first position. The relative position of the intelligent device relative to the intelligent speaker is determined based on the relative angle 1 and the relative angle 2. Exemplarily, the relative angle 1 is φ₁, and the relative angle 2 is φ₂; determining the relative position of the intelligent device relative to the intelligent speaker based on the relative angle 1 and the relative angle 2 includes determining R₂, wherein

$${R}_{2} = Δ T * c * \frac{sin {φ}_{1}}{sin {φ}_{2} - sin {φ}_{1}} ,$$

where R₂ is the distance between the second position and the intelligent device; c is the propagation speed of sound; ΔT is the difference between the detection time in the detection time window of the first sound detection module for the sound signal directly reaching the first sound detection module at the first position and the detection time in the detection time window of the first sound detection module for the sound signal directly reaching the first sound detection module at the second position, or the difference between the detection time in the detection time window of the second sound detection module for the sound signal directly reaching the second sound detection module at the first position and the detection time in the detection time window of the second sound detection module for the sound signal directly reaching the second sound detection module at the second position.

The typical embodiment that the intelligent device calculates the distance to the intelligent speaker is exemplarily described above. Those skilled in the art can understand that the description is only exemplary and is not intended to limit the scope of protection of the embodiment of the present application. For example, the intelligent devices may also determine the distance to the intelligent speaker through infrared ranging, Bluetooth ranging, non-time synchronous ultrasonic ranging, etc.

Further, the intelligent device further carries the distance between the intelligent device and the intelligent speaker in the notification message, so that a loudspeaker array in the intelligent speaker directionally transmits a sound to the intelligent device based on the relative angle and the distance. The volume of the sound has a monotonic increasing relationship with the distance.

Exemplarily, when the loudspeaker array technology is used to achieve directional sounding, the volume of the directionally transmitted sound may be further controlled by combining the distance between the intelligent speaker and the intelligent device. For example, when the distance is larger, the volume of the sound from the intelligent speaker is larger, thus overcoming the path transmission attenuation. Therefore, the present application can also realize the adaptive adjustment of audio volume and direction according to the user position and position change, improve the intelligence of the speaker, and make the user experience better.

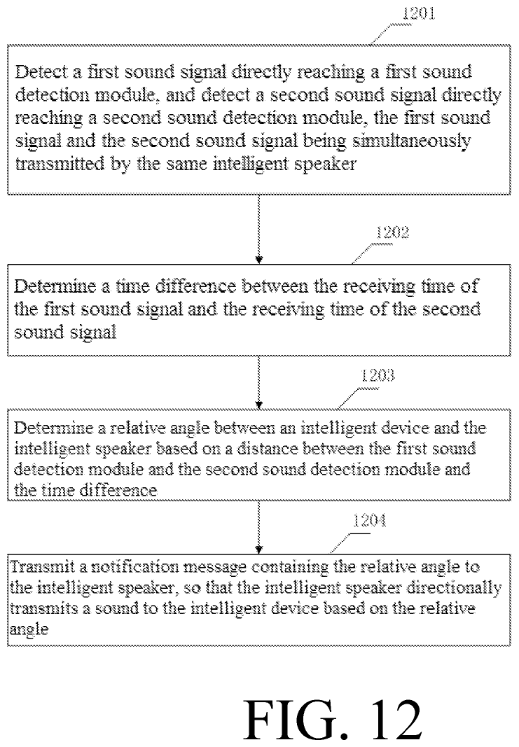

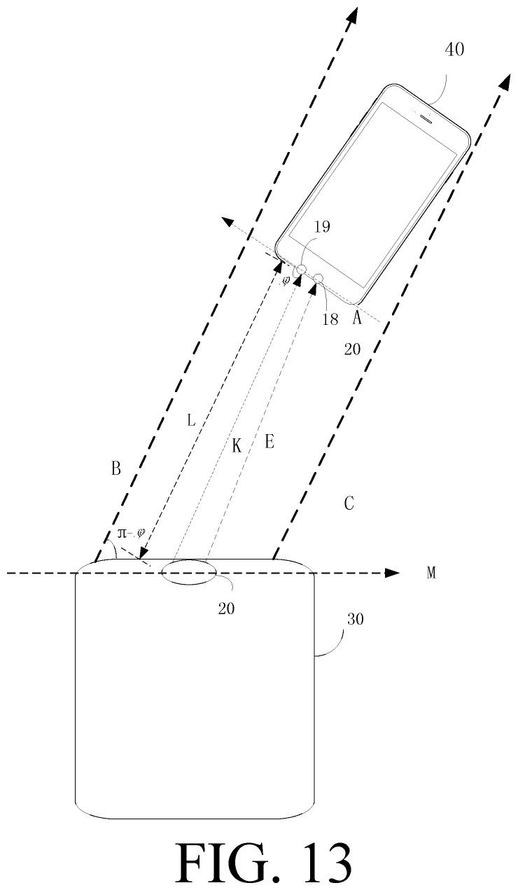

FIG. 12 illustrates a flowchart of a method for controlling an intelligent speaker according to the present application. The method is applicable to an intelligent device including a first sound detection module and a second sound detection module.

Referring to FIG. 12, the method includes the following steps:

In step 1201, a first sound signal directly reaching the first sound detection module is detected, and a second sound signal directly reaching the second sound detection module is detected. The first sound signal and the second sound signal are simultaneously transmitted by the same intelligent speaker.

In step 1202, a time difference between the receiving time of the first sound signal and the receiving time of the second sound signal is determined.

In step 1203, a relative angle between the intelligent device and the intelligent speaker is determined based on a distance between the first sound detection module and the second sound detection module and the time difference.

In step 1204, a notification message containing the relative angle is transmitted to the intelligent speaker, so that the intelligent speaker directionally transmits a sound to the intelligent device based on the relative angle.

In an embodiment, determining a relative angle between the intelligent device and the intelligent speaker includes determining θ based on

$$θ = arc sin ( \frac{d}{D} ) ,$$

where arcsin is an arcsine function, d=t*c, t is the time difference, c is the propagation speed of sound, and D is the distance between the first sound detection module and the second sound detection module; and determining the relative angle φ between the intelligent device and the intelligent speaker based on θ, where

$$φ = \frac{π}{2} - θ .$$

In an embodiment, the method further includes determining the distance between the intelligent device and the intelligent speaker; and further carrying the distance in the notification message; the intelligent speaker directionally transmitting a sound to the intelligent device based on the relative angle includes directionally transmitting, by a loudspeaker array in the intelligent speaker, a sound to the intelligent device based on the relative angle and the distance. The volume of the sound has a monotonic increasing relationship with the distance.

In an embodiment, the first sound signal and the second sound signal are ultrasonic signals containing an identity of the intelligent speaker. Therefore, by comparing the respective identities in the first sound signal and the second sound signal, the intelligent device can confirm whether the positioning signals detected respectively originate from the same sound source.

FIG. 13 illustrates a structural diagram of a system for controlling an intelligent speaker according to the present application. An intelligent speaker 30 is placed horizontally on the ground. A microphone 20 in the intelligent speaker 30 continuously transmits an ultrasonic signal containing an identity of the intelligent speaker 30. When a user expects the intelligent speaker 30 to directionally play music towards him, the user opens APP in a smart phone 40 and triggers a play button in the APP. A first microphone 18 and a second microphone 19 of the smart phone 40 respectively detect the ultrasonic signal containing the unique identity of the smart phone 40. A distance between the first microphone 18 and the second microphone 19 is D. In a case that a controller in the smart phone 40 determines the identities contained in the ultrasonic signals received by the first microphone 18 and the second microphone 19 are the same, the controller calculates a relative angle φ between the smart phone 40 and the intelligent speaker 30 and a distance L between the smart phone 40 and the intelligent speaker 30. The relative angle φ is an included angle between a connecting line E between the microphone 20 and the first microphone 18 and a connecting line A between the first microphone 18 and the second microphone 19, or an included angle between a connecting line K between the microphone 20 and the second microphone 19 and a connecting line A between the first microphone 18 and the second microphone 19. Since D is small enough relative to L, these two included angles can be regarded as the same.

The smart phone 40 transmits the notification message containing the relative angle φ and the distance L to a server through wireless communication. The server forwards the notification message to the intelligent speaker 30. The intelligent speaker 30 calculates a transmitting angle, which is (π−φ).

In a case that the intelligent speaker 30 is equipped with an ultrasonic directional sounder, it directionally transmits a sound to the smart phone 40 based on the transmitting angle (π−φ). At this time, the range of the directionally transmitted sound is between a line B and a line C. An included angle between the line B/line C and a horizontal line M passing through the microphone 20 is (π−φ). The user holding the smart phone 40 between the line B and the line C can receive and hear the sound directionally, and the volume at any position between the line B and the line C is the same.

In a case that the intelligent speaker 30 is equipped with a loudspeaker array, the loudspeaker array is controlled to directionally transmit a sound to the smart phone 40 based on the transmitting angle (π−φ) and the distance L. The volume of the sound has a monotonic increasing relationship with the distance L. At this time, a main beam of sound covers an area defined by the line B and the line C, and a beam deflection angle of the main beam is (π−φ). Therefore, the user holding the smart phone 40 between the line B and the line C can receive and hear the sound directionally. Moreover, when the distance L is larger, the volume of the sound from the loudspeaker array is larger, thus overcoming the path transmission attenuation to ensure that the volume at any position between the line B and the line C is the same as far as possible.

Based on the above description, the embodiment of the present application further provides an application scenario of controlling an intelligent speaker by using sounding device (such as a smart phone or smart headset) according to the above relative angle calculation method.

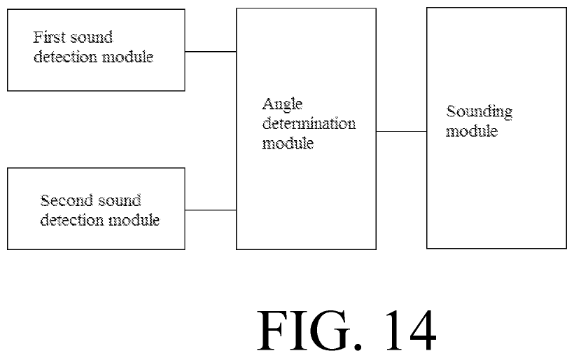

FIG. 14 illustrates a structural diagram of an intelligent speaker according to the present application. A first sound detection module and a second sound detection module are arranged in the intelligent speaker. There is a fixed distance between the first sound detection module and the second sound detection module. The distance between the first sound detection module and the second sound detection module is smaller than the distance to the sounding device. Exemplarily, considering that the sounding device used to control the intelligent speaker is usually several meters away, the distance between the first sound detection module and the second sound detection module is generally not more than 0.5 meters.

Referring to FIG. 14, an intelligent speaker includes a first sound detection module configured to detect a first sound signal directly reaching the first sound detection module; a second sound detection module configured to detect a second sound signal directly reaching the second sound detection module, the first sound signal and the second sound signal being simultaneously transmitted by the same sounding device; an angle determination module configured to determine a time difference between the receiving time of the first sound signal and the receiving time of the second sound signal, and determine a relative angle between the intelligent speaker and the sounding device based on a distance between the first sound detection module and the second sound detection module and the time difference; and a sounding module configured to directionally transmit a sound to the sounding device based on the relative angle.

The sounding device may be implemented as an intelligent device suitable for being held or worn by the user, such as a smart phone, a smart headset, an intelligent remote control, a tablet PC, a personal digital assistant, a smart bracelet, or a pair of smart glasses. The sounding device uses the built-in microphone (or microphone array) to simultaneously transmit a first sound signal directly reaching the first sound detection module and a second sound signal directly reaching the second sound detection module. The first sound detection module and the second sound detection module may be respectively implemented as a microphone or a microphone array. For example, the first sound detection module and the second sound detection module may reuse the original two microphones in the intelligent speaker. Alternatively, two microphones are newly arranged on the intelligent speaker as the first sound detection module and the second sound detection module. Exemplarily, the first sound detection module and the second sound detection module may be arranged at any position in the intelligent speaker, such as a speaker top or wall, which is not limited in the embodiment of the present application.

For the method of calculating the relative angle between the intelligent speaker and the sounding device, a reference may be made to the determination method illustrated in FIG. 1. The intelligent speaker corresponds to the first intelligent device in the method illustrated in FIG. 1, and the sounding device corresponds to the second intelligent device in the method illustrated in FIG. 1. The process of determining the relative angle will not be repeated here. The intelligent speaker may use the built-in controller in the speaker to determine the relative angle, or use an SCM, a single board computer, a DSP or other control modules to determine the relative angle. In an embodiment, the angle determination module is configured to determine θ based on

$$θ = arc sin ( \frac{d}{D} ) ,$$

where arcsin is an arcsine function, d=t*c, t is the time difference, c is the propagation speed of sound, and D is the distance between the first sound detection module and the second sound detection module; and determine the relative angle φ between the intelligent speaker and the sounding device based on θ, where

$$φ = \frac{π}{2} - θ .$$

The sounding module is configured to directionally transmit a sound to the sounding device based on the relative angle. It can be seen that the sound of the intelligent speaker in the present application is no longer diffused in 360 degrees as the traditional way, but directionally transmitted along a certain path.

In an embodiment, the sounding module is configured to control a loudspeaker array to directionally transmit a sound to the sounding device based on the relative angle, or control an ultrasonic directional sounder to directionally transmit a sound to the sounding device based on the relative angle.

Specifically, the sounding module can realize directional sound transmission based on a variety of directional sound technologies. For example:

1. Loudspeaker array technology: a large number of high-frequency speakers are used to form an array to form a beam. A beam direction, that is, a main lobe direction, has the highest energy. The beam direction is aimed at the sounding device located based on this relative angle. Specifically, the sounding module includes an array processor configured to generate an audio signal containing a beam deflection angle aimed at the sounding device based on a transmitting angle; a digital-to-analog converter configured to convert the audio signal to an analog format; a power amplifier configured to perform power amplification on the audio signal output by the digital-to-analog converter; and a loudspeaker array configured to transmit the audio signal output by the power amplifier.

2. Acoustic frequency directional propagation technology based on ultrasound: an audible sound signal is modulated onto an ultrasonic carrier signal and transmitted to the air by an ultrasonic transducer. During the propagation of ultrasonic waves with different frequencies in the air, due to the nonlinear acoustic effect of the air, these signals will interact and be self-demodulated, thus generating a new acoustic wave with a frequency equal to the sum of the original ultrasonic frequencies (sum frequency) and the difference between the frequencies (difference frequency). If the ultrasonic waves are selected properly, the difference-frequency acoustic wave can fall in an audible area. In this way, with the aid of the high directivity of the ultrasound itself, the process of directional propagation of sound is realized. Specifically, the sounding module includes an ultrasonic directional sounder.

The typical embodiment of the sounding module is exemplarily described above. Those skilled in the art can understand that the description is only exemplary and is not intended to limit the scope of protection of the embodiment of the present application.

Specifically, the intelligent speaker can determine the distance between the intelligent speaker and the sounding device based a variety of ways, such as acoustic positioning (ultrasonic positioning preferred).

Example 1: the intelligent speaker keeps time synchronized with the sounding device. The first sound signal further contains the transmitting time T1 of the first sound signal. The intelligent speaker determining the distance between the intelligent speaker and the sounding device includes that a controller in the intelligent speaker calculates the distance L between the intelligent speaker and the sounding device, where L=(T2−T1)*c; c is the propagation speed of sound in the air; T2 is the receiving time of the first sound signal.

Example 2: the intelligent speaker keeps time synchronized with the sounding device. The second sound signal further contains the transmitting time T3 of the second sound signal. The intelligent speaker determining the distance between the intelligent speaker and the sounding device includes that a controller in the intelligent speaker calculates the distance L between the intelligent speaker and the sounding device, where L=(T4−T3)*c; c is the propagation speed of sound in the air; T4 is the receiving time of the second sound signal.

The typical embodiment that the intelligent speaker calculates the distance between the intelligent speaker and the sounding device is exemplarily described above. In fact, the intelligent speaker may also determine the distance to the sounding device through infrared ranging, Bluetooth ranging, non-time synchronous ultrasonic ranging, etc., which is not limited in the embodiment of the present application.

Exemplarily, when the loudspeaker array technology is used to achieve directional sounding, the volume of the directionally transmitted sound may be further controlled by combining the distance between the intelligent speaker and the sounding device. Specifically, the intelligent speaker further includes a distance determination module configured to determine the distance between the intelligent speaker and the sounding device. The sounding module is configured to control the loudspeaker array to directionally transmit a sound to the sounding device based on the relative angle and distance. The volume of the sound has a monotonic increasing relationship with the distance. For example, when the distance is larger, the volume of the sound from the sounding device is larger, thus overcoming the path transmission attenuation. Therefore, the present application can also realize the adaptive adjustment of audio volume and direction according to the user position and position change, improve the intelligence of the speaker, and make the user experience better.

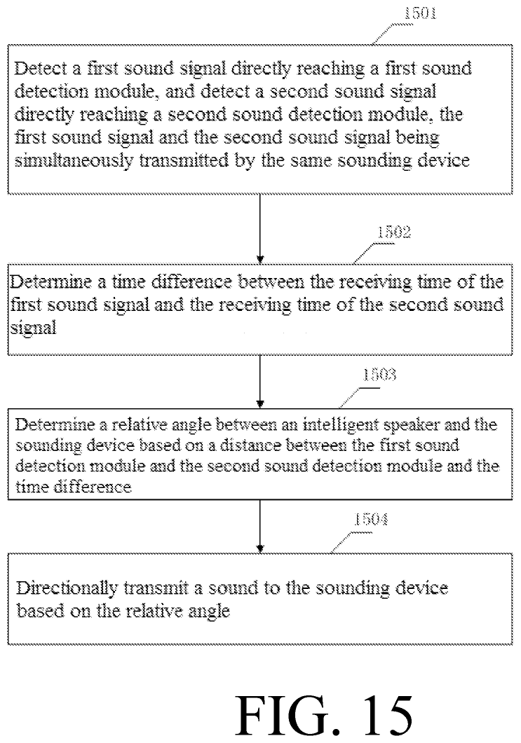

FIG. 15 illustrates a flowchart of a method for controlling an intelligent speaker according to the present application. The intelligent speaker includes a first sound detection module and a second sound detection module. Referring to FIG. 15, the method includes the following steps:

In step 1501, a first sound signal directly reaching the first sound detection module is detected, and a second sound signal directly reaching the second sound detection module is detected. The first sound signal and the second sound signal are simultaneously transmitted by the same sounding device.

In step 1502, a time difference between the receiving time of the first sound signal and the receiving time of the second sound signal is determined.

In step 1503, a relative angle between the intelligent speaker and the sounding device is determined based on a distance between the first sound detection module and the second sound detection module and the time difference.

In step 1504, a sound is directionally transmitted to the sounding device based on the relative angle.

In an embodiment, determining a relative angle between the intelligent speaker and the sounding device based on a distance between the first sound detection module and the second sound detection module and the time difference includes determining θ based on

$$θ = arc sin ( \frac{d}{D} ) ,$$

where arcsin is an arcsine function, d=t*c, t is the time difference, c is the propagation speed of sound, and D is the distance between the first sound detection module and the second sound detection module; and determining the relative angle φ between the intelligent speaker and the sounding device based on θ, where

$$φ = \frac{π}{2} - θ .$$

In an embodiment, directionally transmitting a sound to the sounding device based on the relative angle includes controlling a loudspeaker array to directionally transmit a sound to the sounding device based on the relative angle, or controlling an ultrasonic directional sounder to directionally transmit a sound to the sounding device based on the relative angle; or the method further includes determining the distance between the intelligent speaker and the sounding device; directionally transmitting a sound to the sounding device based on the relative angle includes controlling the loudspeaker array to directionally transmit a sound to the sounding device based on the relative angle and the distance. The volume of the sound has a monotonic increasing relationship with the distance.

In an embodiment, the first sound signal and the second sound signal are ultrasonic signals containing an identity of the sounding device. Therefore, by comparing the identities in the sound signals respectively detected by the first sound detection module and the second sound detection module to determine whether they are the same, the intelligent speaker can determine whether the sound signals originate from the same sound source.

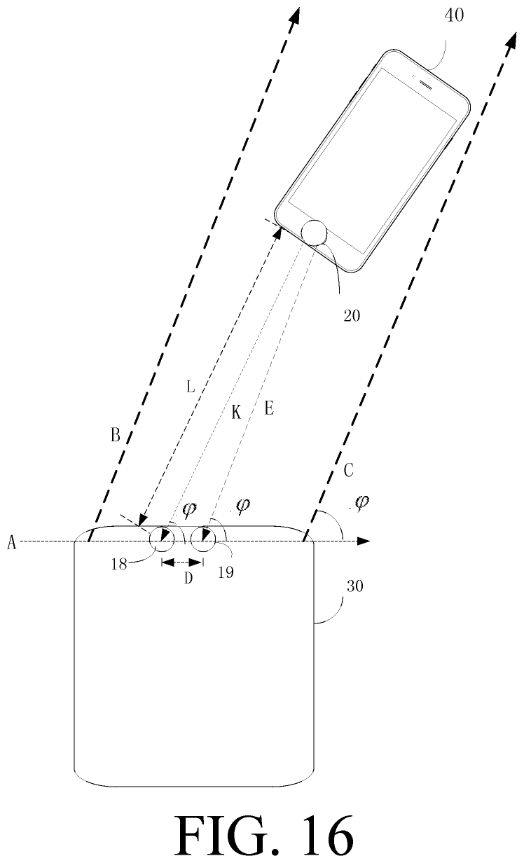

FIG. 16 illustrates a structural diagram of a system for controlling an intelligent speaker according to the present application. In FIG. 16, when a user expects an intelligent speaker 30 to play music towards him, the user opens APP in a smart phone 40 and triggers a play button in the APP. A microphone 20 in the smart phone 40 transmits an ultrasonic signal containing a unique identity of the smart phone 40. A first microphone 18 and a second microphone 19 are closely arranged on a sidewall of the intelligent speaker 30. A distance between the first microphone 18 and the second microphone 19 is D. Moreover, the first microphone 18 and the second microphone 19 respectively receive ultrasonic signals. The first microphone 18 receives a directly reaching ultrasonic signal along a connecting line K between the microphone 20 and the first microphone 18, and the second microphone 19 receives a directly reaching ultrasonic signal along a connecting line E between the microphone 20 and the second microphone 19. In a case that a controller in the intelligent speaker 30 determines the unique identities of the smart phone contained in the directly reaching ultrasonic signals received by the first microphone 18 and the second microphone 19 are the same, the controller calculates a relative angle φ between the intelligent speaker 30 and the smart phone 40 and a distance L between the intelligent speaker 30 and the smart phone 40. The relative angle φ is an included angle between a connecting line K between the microphone 20 and the first microphone 18 and a connecting line A between the first microphone 18 and the second microphone 19, or an included angle between a connecting line E between the microphone 20 and the second microphone 19 and a connecting line A between the first microphone 18 and the second microphone 19. Since D is small enough relative to L, these two included angles can be regarded as the same.

In a case that the intelligent speaker 30 is equipped with an ultrasonic directional sounder, it directionally transmits a sound to the smart phone 40 based on the relative angle φ. At this time, the range of the directionally transmitted sound is between a line B and a line C. An included angle between the line B/line C and the connecting line A is φ. The user holding the smart phone 40 between the line B and the line C can receive and hear the sound directionally, and the volume at any position between the line B and the line C is the same.

In a case that the intelligent speaker 30 is equipped with a loudspeaker array, the loudspeaker array is controlled to directionally transmit a sound to the smart phone 40 based on the relative angle φ and the distance L. The volume of the sound has a monotonic increasing relationship with the distance L. At this time, a main beam of sound covers an area defined by the line B and the line C, and a beam deflection angle of the main beam is φ. Therefore, the user holding the smart phone 40 between the line B and the line C can receive and hear the sound directionally. Moreover, when the distance L is larger, the volume of the sound from the loudspeaker array is larger, thus overcoming the path transmission attenuation to ensure that the volume at any position between the line B and the line C is the same as far as possible.

The embodiment of the present application further provides a computer-readable storage medium, on which a computer program is stored. When the computer program is executed by a processor, each process implemented in each embodiment of the present application is implemented, and the same technical effect can be achieved. In order to avoid repetition, it will not be repeated here. The computer-readable storage medium is a Read Only Memory (ROM), a Random Access Memory (RAM), magnetic disc or compact disc, for example.

The embodiments of the present application are described above with reference to the drawings, but the present application is not limited to the above specific embodiments. The above specific embodiments are only exemplary, not restrictive. Under the inspiration of the present application, without departing from the essence of the present application and the scope of protection of the claims, those skilled in the art may make many variations, all of which still fall within the scope of protection of the present application.

1. An intelligent device, wherein the intelligent device comprises:
a first sound detection module configured to detect a first sound signal directly reaching the first sound detection module;
a second sound detection module configured to detect a second sound signal directly reaching the second sound detection module, the first sound signal and the second sound signal being simultaneously transmitted by the same intelligent speaker;
an angle determination module configured to determine a time difference between the receiving time of the first sound signal and the receiving time of the second sound signal, and determine a relative angle between the intelligent device and the intelligent speaker based on a distance between the first sound detection module and the second sound detection module and the time difference; and
a transmitting module configured to transmit a notification message containing the relative angle to the intelligent speaker, so that the intelligent speaker directionally transmits a sound to the intelligent device based on the relative angle.

2. The intelligent device according to claim 1, wherein
the angle determination module is configured to determine θ based on
$$θ = arc sin ( \frac{d}{D} )$$
where arcsin is an arcsine function, d=t*c, t is the time difference, c is the propagation speed of sound, and D is the distance between the first sound detection module and the second sound detection module; and determine the relative angle φ between the intelligent device and the intelligent speaker based on θ, where
$$φ = \frac{π}{2} - θ .$$

3. The intelligent device according to claim 1, wherein
the intelligent device is a smart phone, a smart headset, an intelligent remote control, a tablet PC, a personal digital assistant, a smart bracelet, or a pair of smart glasses.

4. A method for controlling an intelligent speaker, wherein the method is applicable to an intelligent device comprising a first sound detection module and a second sound detection module, and the method comprises:
detecting a first sound signal directly reaching the first sound detection module, and detecting a second sound signal directly reaching the second sound detection module, the first sound signal and the second sound signal being simultaneously transmitted by the same intelligent speaker;
determining a time difference between the receiving time of the first sound signal and the receiving time of the second sound signal;
determining a relative angle between the intelligent device and the intelligent speaker based on a distance between the first sound detection module and the second sound detection module and the time difference; and
transmitting a notification message containing the relative angle to the intelligent speaker, so that the intelligent speaker directionally transmits a sound to the intelligent device based on the relative angle.

5. The method for controlling the intelligent speaker according to claim 4, wherein determining a relative angle between the intelligent device and the intelligent speaker comprises determining θ based on
$$θ = arc sin ( \frac{d}{D} ) ,$$
where arcsin is an arcsine function, d=t*c, t is the time difference, c is the propagation speed of sound, and D is the distance between the first sound detection module and the second sound detection module; and determining the relative angle φ between the intelligent device and the intelligent speaker based on θ, where
$$φ = \frac{π}{2} - θ .$$

6. The method for controlling the intelligent speaker according to claim 4, wherein the method further comprises determining the distance between the intelligent device and the intelligent speaker; and further carrying the distance in the notification message;
wherein the intelligent speaker directionally transmitting a sound to the intelligent device based on the relative angle comprises, directionally transmitting, by a loudspeaker array in the intelligent speaker, a sound to the intelligent device based on the relative angle and the distance, wherein the volume of the sound has a monotonic increasing relationship with the distance.

7. A system for controlling an intelligent speaker, wherein the system comprises:
the intelligent speaker configured to transmit a sound signal; and
an intelligent device comprising a first sound detection module configured to detect a first sound signal directly reaching the first sound detection module in the sound signal; a second sound detection module configured to detect a second sound signal directly reaching the second sound detection module in the sound signal, the first sound signal and the second sound signal being simultaneously transmitted by the same intelligent speaker; an angle determination module configured to determine a time difference between the receiving time of the first sound signal and the receiving time of the second sound signal, and determine a relative angle between the intelligent device and the intelligent speaker based on a distance between the first sound detection module and the second sound detection module and the time difference; and a transmitting module configured to transmit a notification message containing the relative angle to the intelligent speaker,
wherein the intelligent speaker is further configured to directionally transmit a sound to the intelligent device based on the relative angle.

8. The system for controlling the intelligent speaker according to claim 7, wherein
the intelligent speaker is configured to determine a transmitting angle based on the relative angle and directionally transmit a sound to the intelligent device according to the transmitting angle.

9. The system for controlling the intelligent speaker according to claim 7, wherein
the intelligent device is a smart phone, a smart headset, an intelligent remote control, a tablet PC, a personal digital assistant, a smart bracelet, or a pair of smart glasses.

10. An intelligent speaker, wherein the intelligent speaker comprises:
a first sound detection module configured to detect a first sound signal directly reaching the first sound detection module;
a second sound detection module configured to detect a second sound signal directly reaching the second sound detection module, the first sound signal and the second sound signal being simultaneously transmitted by the same sounding device;
an angle determination module configured to determine a time difference between the receiving time of the first sound signal and the receiving time of the second sound signal, and determine a relative angle between the intelligent speaker and the sounding device based on a distance between the first sound detection module and the second sound detection module and the time difference; and
a sounding module configured to directionally transmit a sound to the sounding device based on the relative angle.

11. The intelligent speaker according to claim 10, wherein
the angle determination module is configured to determine θ based on
$$θ = arc sin ( \frac{d}{D} ) ,$$
where arcsin is an arcsine function, d=t*c, t is the time difference, c is the propagation speed of sound, and D is the distance between the first sound detection module and the second sound detection module; and determine the relative angle φ between the intelligent speaker and the sounding device based on θ, where
$$φ = \frac{π}{2} - θ .$$

12. The intelligent speaker according to claim 10, wherein
the sounding module is configured to control a loudspeaker array to directionally transmit a sound to the sounding device based on the relative angle, or control an ultrasonic directional sounder to directionally transmit a sound to the sounding device based on the relative angle; or
the intelligent speaker further comprises a distance determination module configured to determine the distance between the intelligent speaker and the sounding device, wherein the sounding module is configured to control the loudspeaker array to directionally transmit a sound to the sounding device based on the relative angle and the distance, wherein the volume of the sound has a monotonic increasing relationship with the distance.

13. A method for controlling an intelligent speaker, wherein the intelligent speaker comprises a first sound detection module and a second sound detection module, and the method comprises:
detecting a first sound signal directly reaching the first sound detection module, and detecting a second sound signal directly reaching the second sound detection module, the first sound signal and the second sound signal being simultaneously transmitted by the same sounding device;
determining a time difference between the receiving time of the first sound signal and the receiving time of the second sound signal;
determining a relative angle between the intelligent speaker and the sounding device based on a distance between the first sound detection module and the second sound detection module and the time difference; and
directionally transmitting a sound to the sounding device based on the relative angle.

14. The method for controlling the intelligent speaker according to claim 13, wherein determining a relative angle between the intelligent speaker and the sounding device based on a distance between the first sound detection module and the second sound detection module and the time difference comprises:
determining θ based on
$$θ = arc sin ( \frac{d}{D} ) ,$$
where arcsin is an arcsine function, d=t*c, t is the time difference, c is the propagation speed of sound, and D is the distance between the first sound detection module and the second sound detection module; and determining the relative angle φ between the intelligent speaker and the sounding device based on θ, where
$$φ = \frac{π}{2} - θ .$$

15. The method for controlling the intelligent speaker according to claim 13, wherein
directionally transmitting a sound to the sounding device based on the relative angle comprises controlling a loudspeaker array to directionally transmit a sound to the sounding device based on the relative angle, or controlling an ultrasonic directional sounder to directionally transmit a sound to the sounding device based on the relative angle; or
the method further comprises determining the distance between the intelligent speaker and the sounding device, wherein directionally transmitting a sound to the sounding device based on the relative angle comprises controlling the loudspeaker array to directionally transmit a sound to the sounding device based on the relative angle and the distance, wherein the volume of the sound has a monotonic increasing relationship with the distance.

16. The method for controlling the intelligent speaker according to claim 13, wherein the first sound signal and the second sound signal are ultrasonic signals containing an identity of the sounding device.

17. A system for controlling an intelligent speaker, wherein the system comprises:
a sounding device; and
an intelligent speaker comprising a first sound detection module configured to detect a first sound signal directly reaching a first sound detection module; a second sound detection module configured to detect a second sound signal directly reaching a second sound detection module, the first sound signal and the second sound signal being simultaneously transmitted by the sounding device; an angle determination module configured to determine a time difference between the receiving time of the first sound signal and the receiving time of the second sound signal, and determine a relative angle between the intelligent speaker and the sounding device based on a distance between the first sound detection module and the second sound detection module and the time difference; and a sounding module configured to directionally transmit a sound to the sounding device based on the relative angle.

18. The system for controlling the intelligent speaker according to claim 17, wherein the sounding device is a smart phone, a smart headset, an intelligent remote control, a tablet PC, a personal digital assistant, a smart bracelet, or a pair of smart glasses.

19. A computer-readable storage medium, storing computer-readable instructions for executing the method for controlling the intelligent speaker according to claim 4.

20. The method for controlling the intelligent speaker according to claim 14, wherein the first sound signal and the second sound signal are ultrasonic signals containing an identity of the sounding device.

21. The method for controlling the intelligent speaker according to claim 15, wherein the first sound signal and the second sound signal are ultrasonic signals containing an identity of the sounding device.

22. A computer-readable storage medium, storing computer-readable instructions for executing the method for controlling the intelligent speaker according to claim 5.

23. A computer-readable storage medium, storing computer-readable instructions for executing the method for controlling the intelligent speaker according to claim 6.

24. A computer-readable storage medium, storing computer-readable instructions for executing the method for controlling the intelligent speaker according to claim 13.

25. A computer-readable storage medium, storing computer-readable instructions for executing the method for controlling the intelligent speaker according to claim 14.

26. A computer-readable storage medium, storing computer-readable instructions for executing the method for controlling the intelligent speaker according to claim 15.

27. A computer-readable storage medium, storing computer-readable instructions for executing the method for controlling the intelligent speaker according to claim 16.
